(19) United States
(12) Patent Application Publication
(10) Pub. No.: US 2021/0170697 A1
(43) Pub. Date: Jun. 10, 2021

(54) MULTI PART PLASTIC ASSEMBLY THAT SIMPLIFIES THE APPLICATION OF PRIMER SOLVENTS AND PLASTIC BONDING CEMENTS AND/OR AGENTS TO PLASTIC AND/OR PVC PIPING

(71) Applicant: Michael Dale MCGEE, Lake Havasu City, AZ (US)

(72) Inventor: Michael Dale MCGEE, Lake Havasu City, AZ (US)

(21) Appl. No.: 17/089,644

(22) Filed: Nov. 4, 2020

Related U.S. Application Data
(63) Continuation-in-part of application No. 16/706,728, filed on Dec. 7, 2019.

(51) Int. Cl. B29C 65/52; B29C 65/48; B29C 65/00

(52) U.S. Cl. CPC B29C 65/524; B29C 65/482; B29K 2427/06; B29C 66/71; B29C 66/861; B29C 66/612

(57) ABSTRACT

The present invention is a system and method facilitating the application of PVC primer/cement to the inner surfaces of PVC pipes, unions, joints, or connection sleeves, and to the outer surface of PVC pipes. The invention consists of a PVC primer/cement reservoir, a method of filing and pressurizing the reservoir, and forcing PVC primer or cement through a series of tubes and holes in the apparatus and into a foam applicator transferring PVC primer/cement onto the inner surface or onto the outer surface of a PVC union, sleeve, or pipe to a predetermined depth and thickness thus reducing waste of the PVC primer/cement and ensuring an even coating of PVC primer/cement and always applying the same consistent application of PVC primer/cement.

### CROSS REFERENCE TO RELATED APPLICATIONS

This application is a continuation-in-part of U.S. patent application Ser. No. 16/706,728, filed Dec. 7, 2019, entitled “MULTI PART PLASTIC ASSEMBLY THAT SIMPLIFIES THE APPLICATION OF PRIMER SOLVENTS AND PLASTIC BONDING CEMENTS AND/OR AGENTS TO PLASTIC AND/OR PVC PIPING” the teachings of which are incorporated herein in its entirety by reference.

### FIELD OF INVENTION

The field of invention relates to devices that dispense primer solvent and plastic cement solutions onto and into plastic and/or PVC tubing in residential and commercial construction.

### BACKGROUND

New construction of residences and commercial structures more and more are using plastic and PVC piping for both interior and exterior applications. Typical application of both primer solvents and plastic cement solution onto the interior of plastic and PVC union connections or connection sleeves, and onto the exterior surface of plastic and PVC pipes generally results in either too little or too much primer solvents and too little or too much plastic cement.

The result of over application of primer solvents to the interior surfaces of unions and angled joints can cause roughening of the portion of the union or joint allowing particle matter traveling through the finished piping a surface to catch onto resulting in bacteria and algae growth. The under application of primer solvents to the interior surfaces of unions and angled joints can result in a weak bond when a plastic or PVC pipe coated on the exterior portion of the pipe coated with plastic cement is inserted into the joint union. If the interior surface of the union is not properly prepared with a solvent primer, the plastic cement on the surface of the inserted plastic or PVC pipe may not properly bond with the interior surface of the union. This may result in a failed joint when the pipe assembly is put under pressure.

The result of over application of the plastic cement results in plastic cement buildup inside the end of the plastic or PVC pipe where it is inserted into the union. This buildup of plastic cement may result in microparticles of the cement breaking off the buildup and flowing away in the liquid stream passing through the pipe. If the liquid stream inside the pipe is water and is providing drinking water to people ingesting the water, the microparticles of the plastic pipe may be harmful to their health. Under application of plastic cement to the exterior of the plastic or PVC pipe the surface area of the bonding region between the pipe and the union is diminished. This may result in a failed joint when the pipe assembly is put under pressure.

### Problem Statement

What is needed is some device or system to guarantee the application of primer and plastic cement to the exterior surface of the pipe and the interior surface of the union without over or under application of the primer or the cement thus facilitating a more perfect joining of the pipe and union.

### SUMMARY

The instant invention discloses a number of devices and systems to alleviate most or all of the problems if installing plastic or PVC thin and heavy walled piping by simplifying the process of applying priming solutions and cements or other bonding solutions to making a joining of the pipes permanent.

### EMBODIMENTS

Reference will now be made in detail to various embodiments, examples of which are illustrated in the accompanying drawings. Wherever possible, the same reference numbers will be used throughout the drawings to refer to the same or like parts.

A first exemplary embodiment is disclosed where a handheld applicator consists of a circular tube open at one end and containing a saturable foam disk with a circular hole in the center of the saturable foam disk. The diameter of said circular hole is equal to the outer diameter of a PVC pipe. The circular tube contains a reservoir disk that supports the saturable foam disk and an open space between the bottom of the reservoir disk and the bottom of the circular tube constituting a reservoir. A plurality of holes in the reservoir disk allows the pumped PVC primer/cement to flow into the saturable foam disk resting on the reservoir disk. A pump tube communicably connects the reservoir residing in the bottom of the handheld applicator and the manually activated pump. When the handheld applicator is depressed by a user, the action of depressing the handheld applicator activates the manually activated pump in the PVC primer/cement reservoir causing PVC primer/cement to be pumped through the pump tube to the reservoir in the bottom of the handheld applicator and through the plurality of holes in the reservoir disk to the saturable foam disk.

A related embodiment is disclosed where a handheld applicator consists of a circular tube open at one end and containing a circular saturable foam plug in the center of the handheld applicator. The diameter of said foam plug is equal to the inside diameter of a PVC pipe, union, joint, or connection sleeve. The circular tube contains a reservoir disk that supports the saturable foam plug and an open space between the bottom of the reservoir disk and the bottom of the circular tube constituting a reservoir. A plurality of holes in the reservoir disk allows the pumped PVC primer/cement to flow into the saturable foam plug resting on the reservoir disk. A pump tube communicably connects the reservoir residing in the bottom of the handheld applicator and the manually activated pump. When the handheld applicator is depressed by a user, the action of depressing the handheld applicator activates the manually activated pump in the PVC primer/cement reservoir causing PVC primer/cement to be pumped through the pump tube to the reservoir in the bottom of the handheld applicator and through the plurality of holes in the reservoir disk to the saturable foam plug.

### Definitions

Handheld applicator: The purpose of the handheld applicator is to contain a circular foam disk which contains a circular hole in the center of the circular foam disk. The diameter of the circular hole is the same as the outer diameter of a PVC pipe that the handheld applicator will apply an even coating of PVC primer or PVC cement.

PVC Primer: The purpose of PVC primer is to begin the chemical reaction that softens PVC and to provide an even prepped surface for the solvent cement.

PVC Cement: PVC Cement is a solvent. PVC pipe connected to sleeves and unions through solvent welding.

PVC primer/cement reservoir container: is a closed container with a manually activated pump with a pump tube passing through the container to a handheld applicator. When the user presses downward on the handheld applicator the action is transferred to the manually activated pump through the pump tube initiating a pumping action pumping the PVC primer/cement through the pump tube to the handheld applicator.

Saturable foam disk: Is a circular foam disk which contains a circular hole in the center of the circular foam disk. The diameter of the circular hole is the same as the outer diameter of a PVC pipe that the handheld applicator will apply an even coating of PVC primer or PVC cement.

Saturable foam plug: Is a circular foam plug in the center of the handheld application applier. The circular foam plug diameter is the same as the inner diameter of a PVC pipe, union, joint, or connection sleeve. The PVC pipe, union, joint, or connection sleeve is fitted over the circular foam plug, and either the PVC pipe, union, joint, or connection sleeve or the handheld application applier containing the saturable foam plug is twisted and the PVC primer/cement is applied to the inner surface of the PVC pipe, union, joint, or connection sleeve.

### BRIEF DESCRIPTION OF THE DRAWINGS

FIG. 1 is a side view depiction of the invention

FIG. 2 is a top view depiction of a foam disk with a center cavity for applying PVC primer or PVC cement to the outside of a PVC pipe.

FIG. 3 is a top view depiction of a foam plug applying PVC primer or PVC cement to the inside of a PVC joint sleeve.

FIG. 4 is a side view depiction of a liquid pump prior art.

FIG. 5 is a side view depiction of a liquid pump inside a PVC primer or PVC cement can or similar reservoir.

FIG. 6, is a side view depiction of the invention mounted on top of a PVC primer or PVC cement can with a liquid pump

FIG. 7, is a side view of the invention with a liquid pump inserted into the invention and a top view of a foam disk with a center cavity

FIG. 8 is a side view of the invention with a liquid pump inserted into the invention and a top view of a foam plug for applying PVC primer or PVC cement to the inside of a PVC joint sleeve

### DETAILED DESCRIPTION OF THE INVENTION

Objects and advantages of the present invention will become apparent to those skilled in the art upon reading this description in conjunction with the accompanying drawings, in which like reference numerals have been used to designate like or analogous elements.

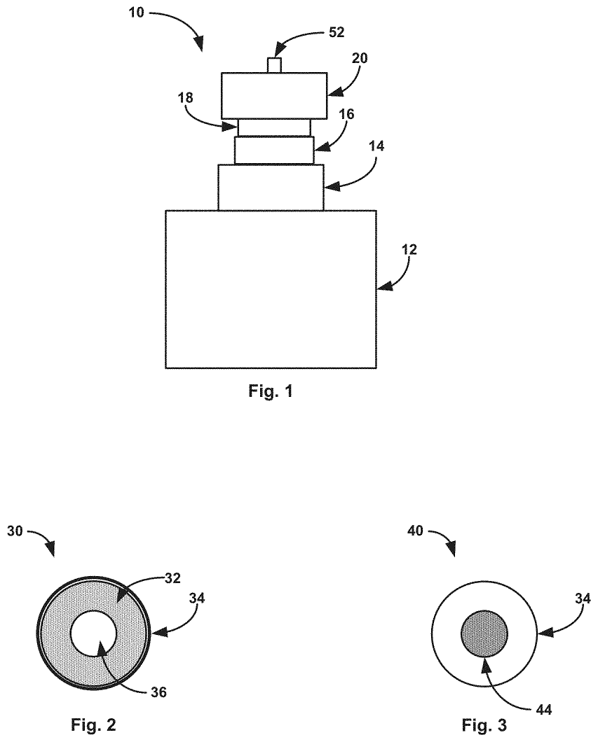

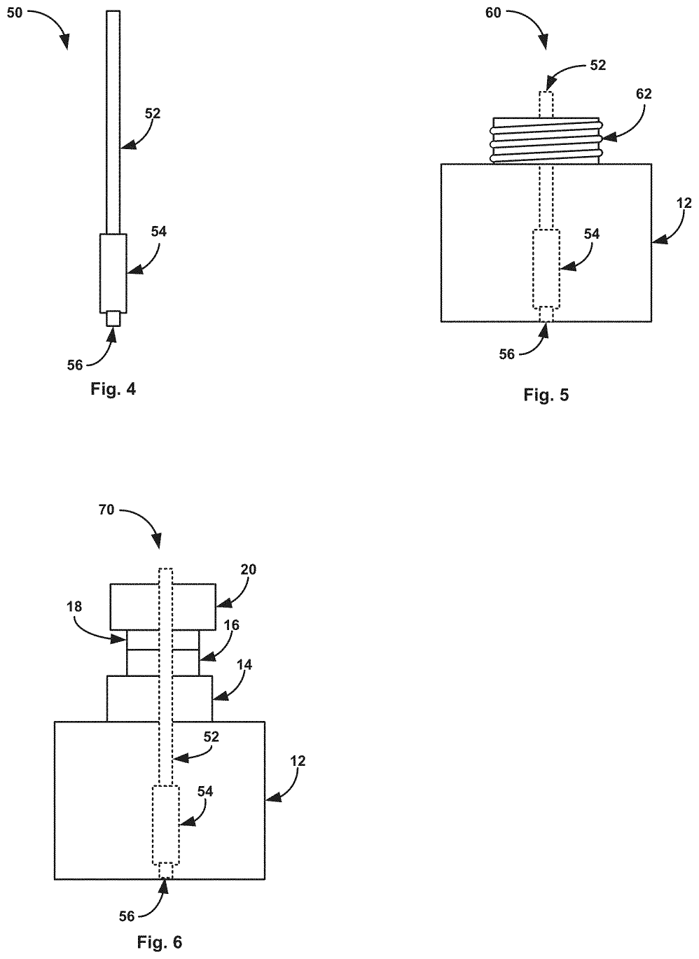

Now referencing FIG. 1 where 10 depicts and external view of the reservoir and pump assembly of the invention. In this depiction, reservoir body 12 holds a volume of primer or cement. Reservoir cap 14 is screwed onto a threaded fixture of reservoir body 12 (see FIG. 5). Spring loaded assembly top 16 and spring loaded assembly bottom 18 contain a coil spring keeping the top and bottom portions of the assembly separated. Lift tube holder 20, when pressed moves life tube 52 downward into pump mechanism 54 (see FIGS. 4, 5, and 6). A check value (not shown) in the body of pump mechanism 54 allows lift tube 52 to partly fill with whatever fluid is in reservoir body. The action of compressing spring loaded assembly top compresses the spring and when the user releases pressure on lift tube holder 20, life tube 52 raises releasing pressure on lift tube pump which closes the check value (not shown) in the body of pump mechanism 54 allowing pump mechanism 54 to refill with primer or cement.

Now referencing FIG. 2 where 36 depicts a foam outside dimension applicator 32. Foam outside dimension applicator 32 contains a hole into which a plastic pipe is inserted. Foam outside dimension applicator 32 will be saturated with primer or cement and a pipe inserted into hole 36 will have its outside surface coated with primer or cement from the saturated foam outside dimension applicator. Foam applicator 32 is contained within foam applicator 34.

Now referencing FIG. 3 where 40 depicts a foam inside dimension applicator 44. When Foam ID applicator 44 is inserted into a plastic pipe, its inner wall be coated with primer or cement from the saturated foam ID applicator 44. Foam ID applicator 44 is contained within foam applicator 34.

Now referencing FIG. 4 where 50 depicts the lift tube pump mechanism, and intake tube assembly consisting of lift tube 52, pump mechanism 54, and pump intake tube 56. When lift tube 52 is pressed downward it moves into pump mechanism 54 (see FIGS. 4, 5, and 6). A check value (not shown) in the outside dimension of pump mechanism 54 allows lift tube 52 to partly fill with fluid in its reservoir body 12. When life tube 52 raises, pressure on lift tube pump mechanism 54 closes the check value (not shown) in the body of pump mechanism 54 allowing pump mechanism 54 to refill with primer or cement via pump mechanism intake tube 56.

Now referencing FIG. 5 where 60 depicts a cutaway view of reservoir body 12 with a threaded top 62 which secures reservoir cap 14 (FIG. 6). Lift tube 52 is shown connected to pump mechanism 54 which is connected to pump mechanism intake tube 56. The reciprocating action of lift tube 52, pump mechanism 54, and pump mechanism intake tube 56 is described above for FIGS. 1 and 4.

Now referencing FIG. 6 where 70 depicts a side cut away view of the lift tube 52, and pump mechanism 54 and pump mechanism intake tube 56. In this depiction, reservoir body 12 holds a volume of primer or cement. Reservoir cap 14 is screwed onto a threaded fixture of reservoir body 12 (see FIG. 5). Spring loaded assembly top 16 and spring loaded assembly bottom 18 contain a coil spring keeping the top and bottom portions of the assembly separated. Lift tube holder 20, when pressed moves lift tube 52 downward into pump mechanism 54 (see FIGS. 4, 5, and 6). A check value (not shown) in the body of pump mechanism 54 allows lift tube 52 to partly fill with PVC primer or PVC cement from reservoir body 12. The action of compressing spring loaded assembly top compresses the spring and when the user releases pressure on lift tube holder 20, lift tube 52 raises releasing pressure on lift tube pump which closes the check value (not shown) in the body of pump mechanism 54 allowing pump mechanism 54 to refill with primer or cement.

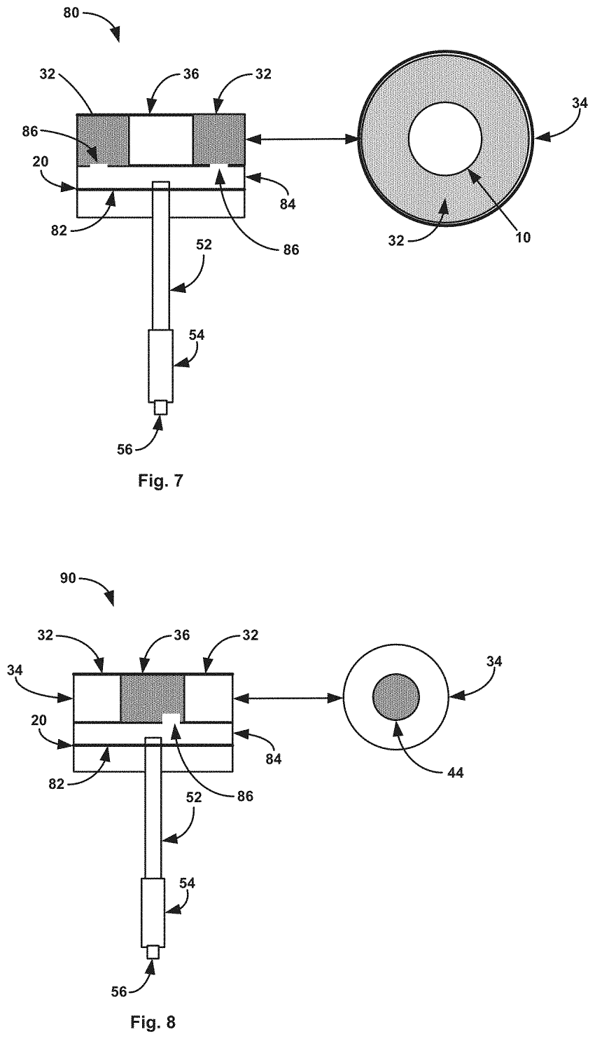

Now referencing FIG. 7 where 80 depicts a view of the lift tube 52 and pump mechanism 54 and pump mechanism intake tube 56. This assembly is shown connected to the assembly containing foam outside dimension applicator 32 and inside foam applicator housing 34. As foam applicator housing 34 is repeatedly pressed downward and allowed to return upward, PVC primer or cement will be pumped via pumping mechanism 54 to reservoir 84 and into foam applicator housing 34 via holes 86 saturating foam outside dimension applicator 32.

Now referencing FIG. 8 where 90 depicts a view of the lift tube 52 and pump mechanism 54 and pump mechanism intake tube 56. This assembly is shown connected to the assembly containing the foam inside diameter applicator 44 inside foam applicator housing 34. As foam applicator housing 34 is repeatedly pressed downward and allowed to return upward, primer or cement will be pumped via pumping mechanism 54 to reservoir 84 and into foam applicator 34 via hole 86 saturating foam ID applicator 44.

The inventor intends that only those claims which use the words “means for” are intended to be interpreted under 35 USC 112, sixth paragraph. Moreover, no limitations from the specification are intended to be read into any claims, unless those limitations are expressly included in the claims.

Where a specific numerical value is mentioned herein, it should be considered that the value may be increased or decreased by 20%, while still staying within the teachings of the present application, unless some different range is specifically mentioned. Where a specified logical sense is used, the opposite logical sense is also intended to be encompassed.

The previous description of the disclosed exemplary embodiments is provided to enable any person skilled in the art to make or use the present invention. Various modifications to these exemplary embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

What is claimed is:

1. A system for applying PVC primer/cement to a PVC pipe, union, joint or connection sleeve such that the amount of PVC primer/cement applied to the outside or inside surfaces of said PVC pipe, union, joint or connection sleeve is of a uniform layer for the surface area to be covered by said PVC primer/cement, a PVC primer/cement reservoir container with an integral manually operated pump supplies said PVC primer/cement through a tube communicably coupling said integral manually operated pump to a handheld application applier containing a saturable foam filling, said system comprising the method steps of:
a. said integral manually operated pump and said pump tube residing in said PVC reservoir container holding said PVC primer/cement communicably couples said PVC primer/cement reservoir container to said handheld application applier and pumps said PVC primer/cement from said PVC primer/cement reservoir container when said pump tube is manually depressed when said handheld application applier is pushed downward by a user, and
b. said PVC primer/cement flows from said PVC primer/cement container through said pump tube into said handheld application applier and saturates said foam applicator with said PVC primer/cement, and
c. if said foam applicator in said handheld application applier has a hole in its center whose inner diameter is the same as the outer diameter of said PVC pipe fitted into said hole in said foam applicator, and either said PVC pipe or said handheld application applier is twisted, said PVC primer/cement is applied to said outer surface of said PVC pipe, and
d. if said foam applicator in said handheld application applier is a foam plug located in the center of said handheld applicator applier and said outer diameter of said foam plug is the same as the inner diameter of said PVC pipe, union, joint or connection sleeve fitted onto said foam plug, and either said PVC pipe, union, joint or connection sleeve or said handheld application applier is twisted, said PVC primer/cement is applied to said inner surface of said PVC pipe, union, joint or connection sleeve.

2. Any of the method steps of claim 1 where the thickness of said foam applicator with a hole in the center of said foam applicator contained in said handheld applicator is the same as the depth recommended by the manufacturer of said PVC pipe thus limiting the PVC primer/cement depth of the outer surface area of said PVC pipe receiving said PVC solvent/cement.

3. Any of the method steps of claim 1 where the thickness of said foam plug applicator in said handheld applicator is the same as the PVC primer/cement depth recommended by the manufacturer of said PVC pipe, union, joint or connection sleeve thus limiting the PVC primer/cement depth of the inner surface of said PVC pipe, joint, or union receiving said PVC solvent/cement.

4. A method for applying PVC primer/cement to a PVC pipe, union, joint, or connection sleeve such that the amount of PVC primer/cement applied to the outside or inside surfaces of said PVC pipe, union, joint, or connection sleeve is of a uniform layer for the surface area to be covered by said PVC primer/cement comprising: a PVC primer/cement reservoir container with an integral manually operated pump supplies said PVC primer/cement through a tube communicably coupling said integral manually operated pump to a handheld application applier containing a saturable foam filling, said method comprising:
a. activating said manually operated pump to pump said PVC primer/cement from said PVC primer/cement reservoir container to said handheld application applier by depressing said handheld application applier and in turn said pump tube, and
b. said PVC primer/cement flows from said activated manually operated pump through said pump tube into said handheld application applier saturating said saturable foam filling, and
c. if said saturable foam filling contains a hole in the center of said saturable foam filling whose diameter is the same as the outer diameter of said PVC pipe fitted into said hole in said foam applicator, and either said PVC pipe or said handheld application applier containing said saturable foam filling is twisted, said PVC primer/cement is applied to said outer surface of said PVC pipe, and
d. if said saturable foam filling is a circular foam plug in the center of said handheld application applier and if said circular foam plug diameter is the same as the inner diameter of said PVC pipe, union, joint, or connection sleeve, and said PVC pipe, union, joint, or connection sleeve is fitted over said circular foam plug, and either said PVC pipe, union, joint, or connection sleeve or said handheld application applier containing said saturable foam plug is twisted, said PVC primer/cement is applied to said inner surface of said PVC pipe, union, joint, or connection sleeve.

5. Any of the method steps of claim 4 where the thickness of said saturable foam filling with a hole in the said center of said saturable foam filling contained in said handheld applicator is the same as the depth recommended by the manufacturer of said PVC pipe thus limiting the PVC primer/cement depth of the outer surface area of said PVC pipe receiving said PVC solvent/cement.

6. Any of the method steps of claim 4 where the thickness of said circular foam plug in said handheld applicator is the same as the PVC primer/cement depth recommended by the manufacturer of said PVC pipe, union, joint, or connection sleeve thus limiting the PVC primer/cement depth of the inner surface of said PVC pipe, joint, or union receiving said PVC solvent/cement.
